(19) United States
(12) Patent Application Publication
(10) Pub. No.: US 2014/0353361 A1
(43) Pub. Date: Dec. 4, 2014

(54) ELECTRIC WIRE CONNECTING METHOD AND CONNECTING DEVICE THEREOF

(71) Applicant: YAZAKI CORPORATION, Tokyo (JP)

(72) Inventors: Yuki NUMATA, Makinohara-shi (JP); Ayako SHIMIZU, Makinohara-shi (JP)

(73) Assignee: YAZAKI CORPORATION, Tokyo (JP)

(21) Appl. No.: 14/289,710

(22) Filed: May 29, 2014

(30) Foreign Application Priority Data
May 31, 2013 (JP) 2013-114923

(51) Int. Cl. H01R 43/02

(52) U.S. Cl. CPC H01R 43/0207
USPC 228/110.1; 228/1.1

(57) ABSTRACT

An electric wire connecting device connects a conductor of an electric wire formed of a plurality of core wires to a terminal. The connecting device includes a pair of clamping members for clamping a part of an end portion of the conductor, and a ultrasonic welding horn for connecting the conductor to the terminal via ultrasonic welding in a state where the end portion of the conductor clamped by the clamping members is placed at the terminal.

### BACKGROUND OF THE INVENTION

1. Field of the Invention

The present invention relates to a connecting method and a connecting device each for connecting electric wires applied for various devices to objects to be connected such as terminals.

2. Description of the Related Art

As a structure in which an electronic wire such as a stranded wire formed of a plurality of core wires is electrically connected to a portion to be connected such as a terminal, known is a structure in which an end portion of a conductor which is exposed at the end portion of the electric wire is connected to a terminal at the predetermined connecting position via pressurized ultrasonic junction. The end portion is exposed by stripping off an outer sheath (insulating sheath or covering portion) of the electric wire, for example.

### SUMMARY OF THE INVENTION

The end portion of the above-described conductor is compressed in advance by press-molding in accordance with a shape at the connecting position of a portion to be connected, in order to prevent so-called burr from being generated during ultrasonic welding.

It is an object of the present invention to suppress unravelling of the end portion of the conductor during the ultrasonic junction; to prevent the burr from being generated at the end portion; and to improve reliability of electrical connection between the conductor and an object to be connected (that is, to improve joint strength, and improve performance to avoid occurrence of a short circuit).

A first aspect of the present invention is an electric wire connecting method for connecting a conductor of an electric wire formed of a plurality of core wires to a portion to be connected, including the step of connecting an end portion of the conductor to the portion to be connected via ultrasonic welding, while clamping a part of the end portion of the conductor.

A second aspect of the present invention is an electric wire connecting device for connecting a conductor of an electric wire formed of a plurality of core wires to a portion to be connected, including a clamping unit configured to clamp a part of an end portion of the conductor; and a ultrasonic welding unit configured to connect the end portion of the conductor to the portion to be connected via ultrasonic welding in a state where the end portion of the conductor clamped by the clamping unit is inserted and placed at a contacted portion.

The clamping device may be a pair of clamping members by which the foregoing part of the end portion of the conductor is clamped.

According to the present invention, it is possible to prevent the burr from being generated at the end portion of the conductor, and to improve reliability of electrical connection between the end portion of the conductor and an object to be connected.

### BRIEF DESCRIPTION OF THE DRAWINGS

FIG. 1A is an oblique perspective view showing a stage before a conductor of an electric wire is clamped in an embodiment of the present invention.

FIG. 1B is an oblique perspective view showing an electric wire from which a conductor is exposed.

FIG. 2A is an oblique perspective view showing a state where the conductor of the electric wire is clamped in the foregoing embodiment.

FIG. 2B is an oblique perspective view showing a state where the conductor of the electric wire is joined to a terminal via pressurized ultrasonic junction.

FIG. 3A is an oblique perspective view showing a state where a conductor of an electric wire is press-connected in the related art.

FIG. 3B is an oblique perspective view showing a process in which an end portion of the conductor of the electric wire is connected to a terminal in the related art.

FIG. 3C is an oblique perspective view showing a state where the end portion of the conductor of the electric wire is unraveled in the related art.

### DESCRIPTION OF THE PREFERRED EMBODIMENTS

Hereinafter, the embodiments of the present invention will be described, referring to the drawings.

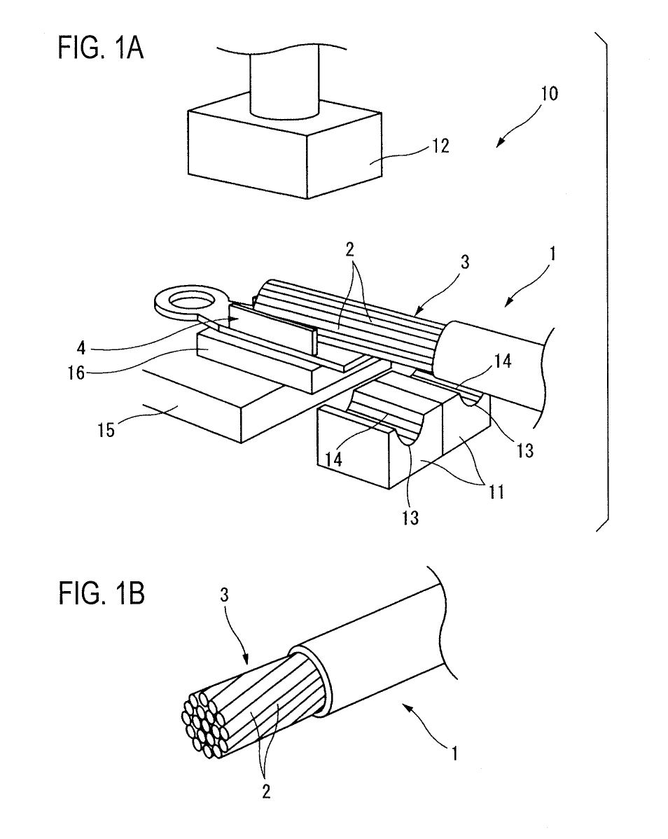

A connecting method of an electric wire 1 in the present embodiment shown in FIGS. 1A and 1B, connects (joins) an end portion of a conductor 3 to a terminal (i.e. a portion to be connected) 4 via ultrasonic welding (pressurized ultrasonic vibration) in a state of clamping a part of the end portion of the conductor 3 of the electric wire 1, the conductor 3 being formed of a plurality of core wires 2. Here, the part of the end portion of the conductor 3, in other words, means an outer circumferential portion in the end portion of the conductor 3 and therearound, or one part of the conductor 3 in the longitudinal direction at the outer circumferential portion of the end portion of the conductor 3.

A connecting device 10 which performs the connecting method in the present embodiment will be described.

The connecting device 10 is a device for connecting the conductor 3 of the electric wire 1 to the terminal 4. As shown in FIG. 1A, the connecting device 10 includes a pair of clamping members 11 as a clamping means (clamping apparatus) for clamping a part of the end portion of the conductor 3 which is exposed from the electric wire 1, and an ultrasonic welding horn (pressurization-vibration horn) 12 as a ultrasonic welding means (pressurization-vibration apparatus) for connecting (joining) the end portion of the conductor 3 to the portion to be connected via ultrasonic welding in a state where the end portion of the conductor 3 whose outer circumferential portion is clamped by clamping members is placed at the portion to be connected of the terminal 4.

The clamping members 11 each have a surface facing the conductor 3 of the electric wire 1 (in other words, the mating clamping member 11) . Grooves (insertion grooves) 13 for receiving (inserting) the conductor 3 are formed in this surface. The diameter of each of the grooves 13 is set in accordance with the diameter of the conductor 3. In addition, grooves 14 for preventing slippage of the conductor 3 may be formed in the inner surface of the groove 13. In this case, the grooves 14 are formed in the inner surface of the groove 13 at appropriate intervals and at an appropriate angle.

In the state where the end portion of the conductor 3 of the electric wire 1 is placed at a portion to be connected of the terminal 4 placed on an underlay 16 on a workbench 15, the ultrasonic welding horn 12 ultrasonically joins this end portion to the portion to be connected while pressurizing the end portion.

The underlay 16 has a contact portion to be contacted with the terminal 4. The contact portion of the underlay 16 may have a shape in accordance with the shape of the terminal 4. In this case, firm attachment between the terminal 4 and the conductor 3 in the electric wire 1 is ensured, resulting in excellent joining.

The connecting process of the electric wire 1 to the terminal 4 will be described, referring to FIGS. 1A and 1B.

As shown in FIG. 1B, first, the conductor 3 is exposed outside by stripping off the outer sheath (insulating sheath or covering portion) of the electric wire 1. As shown in FIG. 1A, the exposed end portion of the conductor 3 is placed at the portion to be connected of the terminal 4 placed in the underlay 16 on the workbench 15. In other words, the end portion of the conductor 3 is inserted in the portion to be connected of the terminal 4, and fitted in the portion to be connected.

Next, a pair of clamping members 11 are guided and placed below the conductor 3 near the workbench 15 with each of the grooves 13 being opened.

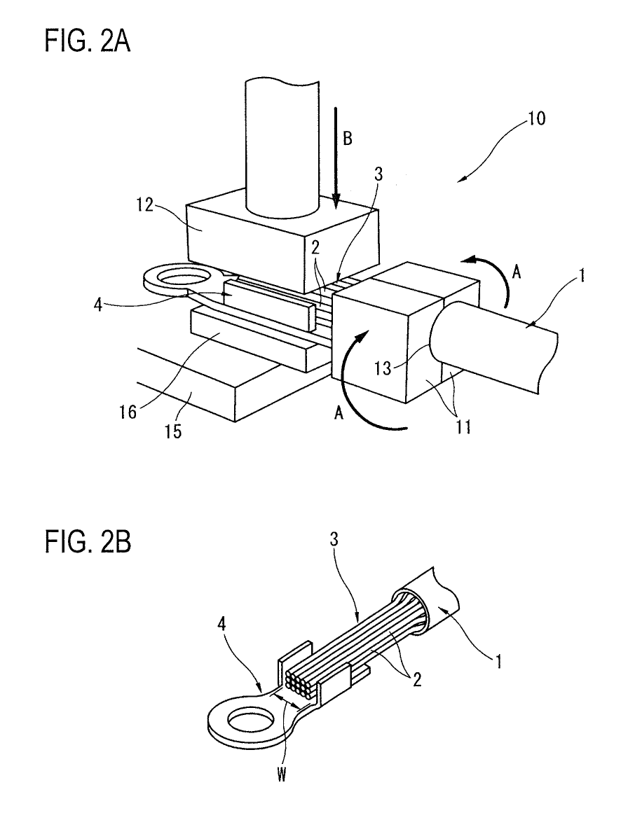

Thereafter, as shown in FIG. 2A, each of the clamping members rocks (turns) in the direction heading toward the outer circumferential portion of the conductor 3 (in the direction of arrow A) . That is, the pair of clamping members 11 rock (turn) so as to close each of the grooves 13. As a result, the end portion of the conductor 3 is partially clamped by the pair of clamping members 11 (in other words, a pair of the grooves 13).

Subsequently, as shown in FIG. 2A, the ultrasonic welding horn 12 ultrasonically vibrates the end portion of the conductor 3 (or the end portion and the surrounding part thereof), while pressurizing the end portion in the radial direction of the conductor 3 (in the direction of arrow B). As a result, as shown in FIG. 2B, the end portion of the conductor 3 is joined to the portion to be connected of the terminal 4. In this connecting process, the expansion of the end portion of the conductor 3 in the width direction of the end portion is regulated by the portion to be connected of the terminal 4. That is, the width of the end portion of the conductor 3 becomes roughly equal to a width W of the portion to be connected of the terminal 4 because of pressurization of the ultrasonic welding horn 12. In this case, enhanced is degree of attachment of the outer circumferential surface of the end portion of the conductor 3 to the portion to be connected of the terminal 4. As described above, the conductor 3 of the electric wire 1 is connected to the terminal 4.

The effects according to the present embodiment will be described below.

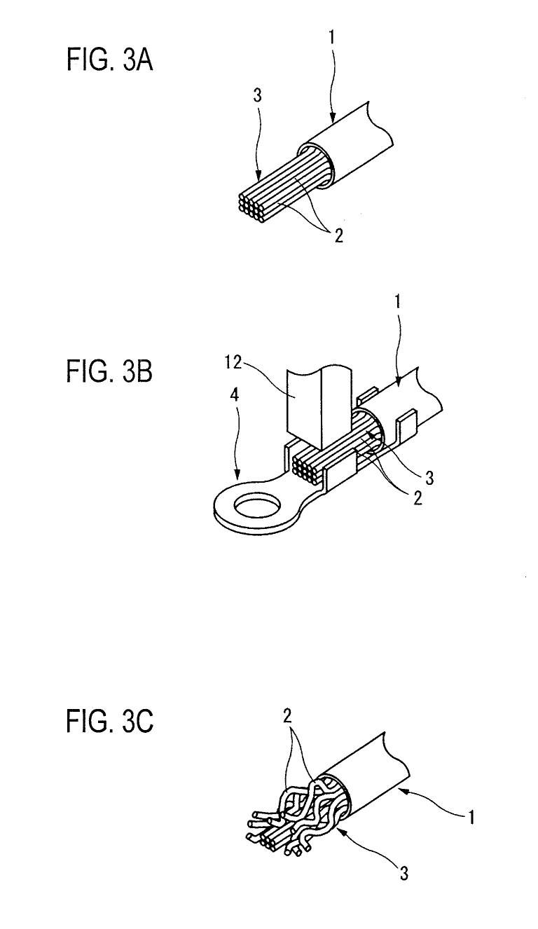

FIG. 3A and FIG. 3B are drawings showing an example of a conventional method for connecting a conductor of an electric wire to a terminal. As shown in each of these drawings, the end portion of the conductor 3 is exposed from the outer sheath of the electric wire 1; is adjusted to the width of the portion to be connected of the terminal 4 to be press-molded in the form of a plate; and is then placed at the portion to be connected. Subsequently, the ultrasonic welding horn 12 connects the end portion having been press-molded to the terminal 4 via ultrasonic welding (refer to Japan Patent Application laid-Open Publications JP 2006-172927 A, JP 2004-95293 A and JP 2009-277445 A).

This conventional method prevents fracture of the conductor during joining of the conductor 3 to the terminal 4 by press-molding the end portion of the conductor 3 in the form of a flat plate before joining by a ultrasonic welding method.

However, when the end portion of the conductor 3 which has been press-molded is subjected to ultrasonic joining, core wires 2 at the end portion may be unraveled. In this case, as shown in FIG. 3C, a part of the core wires 2 slips to the outer sheath side of the conductor 3, and deformation such as undulation, bending or the like is generated in the core wires 2, and burr may be generated at the end portion of the conductor 3. When this burr is generated, reduction in joint strength between the terminal 4 and the conductor 3 and an electric short circuit (short) caused by dropout of the burr may be triggered.

In contrast, in the present embodiment, a part of the end portion of the conductor 3 is clamped in advance by the clamping members 11, when the end portion of the conductor 3 is joined to the terminal 4 via ultrasonic welding of the ultrasonic welding horn 12.

Since a part of the end portion of the conductor 3 is clamped in advance by the clamping members 11, the core wires 2 at the foregoing part are closely attached to each other and are difficult to be unraveled, and the core wires 2 do not slip to the outer sheath side of the conductor 3. Accordingly, generation of burr caused by deformation of the core wires 2 can be suppressed in the connecting process via ultrasonic welding.

The contact area between the conductor 3 and each of the grooves 13 increases, when slip stopper grooves 14 are formed in the inner surface of each of the grooves 13. Accordingly, the core wires 2 of the conductor 3 can be firmly clamped by a pair of the clamping members 11. As a result, unravelling of the core wires 2 at the end portion of the conductor 3 can be more reliably suppressed.

As described above, according to the connecting method of conductor 3 and the connecting device 10 thereof, generation of burr at the end portion of the conductor 3 can be suppressed in the connecting process of the conductor 3 to the terminal 4 via ultrasonic welding.

Accordingly, joint strength between the conductor 3 and the terminal 4 is stabilized, and occurrence of an electric short circuit can be prevented. Thus, it is possible to stabilize quality of the terminal 4 to which the conductor 3 is connected, eliminate the need of an inspection step in the post process, and reduce the manufacturing cost.

What is claimed is:

1. An electric wire connecting method for connecting a conductor of an electric wire formed of a plurality of core wires to a portion to be connected, comprising:
connecting an end portion of the conductor to the portion to be connected via ultrasonic welding, while clamping a part of the end portion of the conductor.

2. An electric wire connecting device for connecting a conductor of an electric wire formed of a plurality of core wires to a portion to be connected, comprising:
a clamping unit configured to clamp a part of an end portion of the conductor; and
a ultrasonic welding unit configured to connect the end portion of the conductor to the portion to be connected via ultrasonic welding in a state where the part of the end portion of the conductor is clamped by the clamping unit, and the end portion of the conductor is placed at a contacted portion.

3. The electric wire connecting device of claim 2, wherein the clamping unit includes a pair of clamping members which clamp the part of the end portion of the conductor.
